(19) United States
(12) Patent Application Publication
(10) Pub. No.: US 2026/0279622 A1
(43) Pub. Date: Sep. 17, 2026

(54) WIDE TERMINAL RESISTOR

(71) Applicant: YAGEO CORPORATION, Kaohsiung City (TW)

(72) Inventors: Lai-Fu HSU, Kaohsiung City (TW); Chun-Kai YANG, Kaohsiung City (TW)

(21) Appl. No.: 19/199,406

(22) Filed: May 6, 2025

(30) Foreign Application Priority Data
Mar. 12, 2025 (TW) 114109121

(51) Int. Cl. H01C 1/14

(52) U.S. Cl. CPC H01C 1/14

(57) ABSTRACT

A wide terminal resistor includes a carrier, a resistance layer, first and second inner electrodes, an insulating protection layer, and first and second outer electrodes. The resistance layer is disposed on the carrier, and includes a resistance functional area, and first and second electrode areas on opposite sides of the resistance functional area. The first and second inner electrodes are disposed on the first and second electrode areas. The first inner electrode includes a first body, a first pedestal, and a first bump. The second inner electrode includes a second body, a second pedestal, and a second bump opposite to the first bump. The insulating protection layer covers the resistance functional area and portions of the first and second inner electrodes. The first and second outer electrodes respectively cover the first inner electrode and the first electrode area, and the second inner electrode, and the second electrode area.

### CROSS-REFERENCE TO RELATED APPLICATIONS

This application claims priority to Taiwan Application Serial Number 114109121, filed Mar. 12, 2025, which is herein incorporated by reference in its entirety.

### BACKGROUND

### Field of Invention

The present disclosure relates to a technology for manufacturing an electronic component, and more particularly, to a wide terminal resistor.

### Description of Related Art

A wide terminal resistor is designed to shorten a path for current to flow through the resistor to increase the power tolerance of the resistor. In addition, the heat generated by the operation of the resistor can also be quickly dispersed by a short path of electrodes.

The electrodes of the wide terminal resistor are wider, such that current directions of the product will be different depending on the wiring positions of current or voltage on a circuit board. This will cause differences in resistance measurement due to the product deviation after the product is soldered onto the circuit board.

In addition, when a trimming operation is performed on the resistor product, probes are used to measure the resistance, and a physical trimming operation is simultaneously performed on the product. In the measuring of the resistance, a deviation will occur in the resistance measurement due to the positions of the probes. Some resistors are designed with fixed probing points to reduce measurement errors in product resistance. However, such a design is also difficult to decrease the resistance deviation resulted from the deviation caused when the product is soldered onto the circuit board.

### SUMMARY

Therefore, one objective of the present disclosure is to provide a wide terminal resistor, which can solve the problems of poor probe measurement accuracy of the wide terminal resistor, and a large error between the probe measurement and the measurement after being mounted on a circuit board.

According to the aforementioned objectives, the present disclosure provides a wide terminal resistor including a carrier, a resistance layer, a first inner electrode, a second inner electrode, an insulating protection layer, a first outer electrode, and a second outer electrode. The resistance layer is disposed on the carrier. The resistance layer includes a resistance functional area, and a first electrode area and a second electrode area respectively located on two opposite sides of the resistance functional area. The first inner electrode is disposed on the first electrode area. The first inner electrode includes a first body, and a first pedestal and a first bump sequentially connected to one side of the first body. The second inner electrode is disposed on the second electrode area. The second inner electrode includes a second body, and a second pedestal and a second bump sequentially connected to one side of the first body. The second bump and the first bump are opposite to each other. The insulating protection layer covers the resistance functional area, a portion of the first inner electrode, and a portion of the second inner electrode. The first outer electrode covers a portion of the insulating protection layer, the first inner electrode, and the first electrode area. The second outer electrode covers another portion of the insulating protection layer, the second inner electrode, and the second electrode area, and is opposite and separated from the first outer electrode.

According to one embodiment of the present disclosure, the resistance layer has two trenches. The trenches respectively pass through two opposite edge areas of the resistance functional area to divide the resistance functional area into a wide resistor, a first narrow resistor, and a second narrow resistor that are connected in parallel. The first narrow resistor and the second narrow resistor are symmetrically arranged on two opposite sides of the wide resistor.

According to one embodiment of the present disclosure, each of a width of the first narrow resistor and a width of the second narrow resistor is ranging from 10% to 20% of a width of the resistance functional area, and a width of each of the trenches is ranging from 50 μm to 500 μm.

According to one embodiment of the present disclosure, a resistance of each of the first narrow resistor and the second narrow resistor is ranging from 2 to 5 times a resistance of the wide resistor.

According to one embodiment of the present disclosure, each of a width of the first pedestal and a width of the second pedestal is equal to or smaller than a width of the wide resistor.

According to one embodiment of the present disclosure, each of a length of the first pedestal protruding from the first body and a length of the second pedestal protruding from the second body is ranging from 25 μm to 100 μm. Each of a length of the first bump protruding from the first pedestal and a length of the second bump protruding from the second pedestal is ranging from 10 μm to 50 μm. Each of a width of the first bump and a width of the second bump is ranging from 10 μm to 50 μm.

According to one embodiment of the present disclosure, a width of the resistance functional area is ranging from ⅖ to ⅘ of a width of the wide terminal resistor. Each of a width of the first electrode area and a width of the second electrode area is ranging from 80% to 95% of the width of the wide terminal resistor.

According to one embodiment of the present disclosure, a length of the resistance functional area is ranging from 3/10 to 6/10 of a length of the resistance layer, and each of a length of the first body and a length of the second body is ranging from ⅙ to 2/6 of a length of the resistance layer.

According to one embodiment of the present disclosure, each of the first bump and the second bump is an arc-shaped structure.

According to one embodiment of the present disclosure, the first inner electrode is mirror symmetrical to the second inner electrode.

According to the above embodiments, the first inner electrode and the second inner electrode are respectively provided with the first bump and the second bump protruding toward the resistance functional area, such that the electric field and current can be concentrated on the first bump and the second bump, which makes the probe measurement more stable. Therefore, the accuracy of the probe measurement of the wide terminal resistor can be increased, and the error between the probe measurement and the measurement on the circuit board of the wide terminal resistor can be effectively reduced.

In addition, the resistance functional area of the resistance layer is provided with two trenches to divide the resistance functional area into a wide resistor, and a first narrow resistor and a second narrow resistor located at two outer sides of the wide resistor. The design can make the electric field on the edges of the resistance functional area uniform, disperse the resistance of the resistor, and achieve uniform heat distribution. Furthermore, the resistance of the first narrow resistor and the second narrow resistor are relatively high, and the electric field can be more concentrated in the central area of the resistance functional area.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic three-dimensional diagram of a wide terminal resistor in accordance with one embodiment of the present disclosure.

FIG. 2 is a schematic diagram of a solder side of a wide terminal resistor in accordance with one embodiment of the present disclosure.

FIG. 3 is a schematic cross-sectional view of the wide terminal resistor taken along a section line A-A of FIG. 1.

FIG. 4 is a schematic cross-sectional view of the wide terminal resistor taken along a section line B-B of FIG. 1.

FIG. 5 through FIG. 12 are schematic diagrams respectively showing intermediate stages in a method for manufacturing a wide terminal resistor in accordance with one embodiment of the present disclosure.

FIG. 13 is a schematic diagram illustrating a resistance measurement operation of a wide terminal resistor using probes.

FIG. 14 is a schematic diagram illustrating paths of current of a conventional wide terminal resistor when a resistance measurement operation is performed using probes.

FIG. 15 is a schematic diagram illustrating paths of current of a wide terminal resistor in accordance with one embodiment of the present disclosure when a resistance measurement operation is performed using probes.

FIG. 16 is a schematic diagram illustrating a resistance measurement operation of a wide terminal resistor after being mounted on a circuit board.

FIG. 17 is a schematic diagram illustrating paths of current of a conventional wide terminal resistor when a resistance measurement operation is performed after the conventional wide terminal resistor is mounted on a circuit board.

FIG. 18 is a schematic diagram illustrating paths of current of a wide terminal resistor in accordance with one embodiment of the present disclosure when a resistance measurement operation is performed after the wide terminal resistor is mounted on a circuit board.

FIG. 19 is a comparison diagram of box plots of data of a wide terminal resistor in accordance with one embodiment of the present disclosure and a conventional wide terminal resistor when a resistance measurement operation is performed using probes.

FIG. 20 is a comparison diagram of box plots of data of a wide terminal resistor in accordance with one embodiment of the present disclosure and a conventional wide terminal resistor when a resistance measurement operation is performed after the wide terminal resistors are mounted on circuit boards.

FIG. 21 is a comparison diagram of a box plot of data of resistance difference of a wide terminal resistor in accordance with one embodiment of the present disclosure between using probes and after being mounted on a circuit board and a box plot of data of resistance difference of a conventional wide terminal resistor between using probes and after being mounted on a circuit board.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

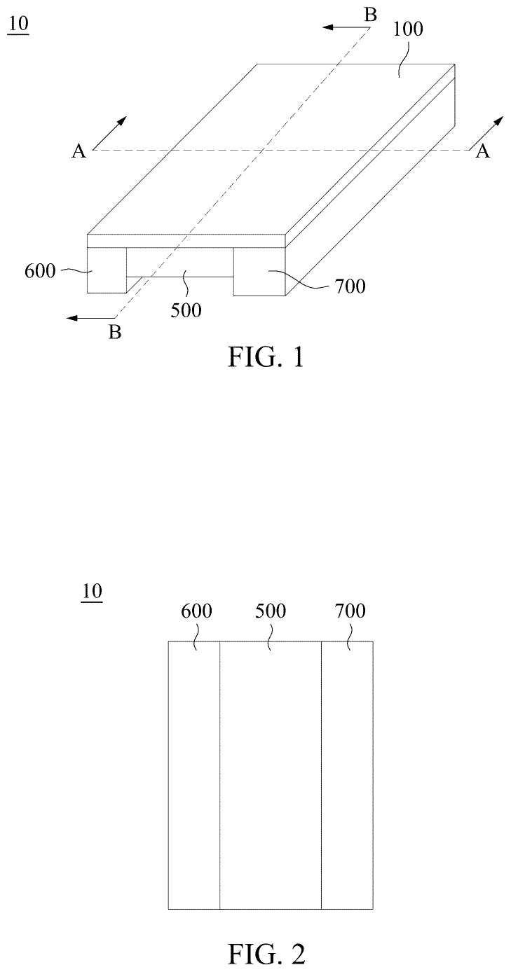

Referring to FIG. 1 through FIG. 4, FIG. 1 through FIG. 4 respectively illustrate a schematic three-dimensional diagram of a wide terminal resistor 10 in accordance with one embodiment of the present disclosure, a schematic diagram of a solder side of the wide terminal resistor 10, and schematic cross-sectional views of the wide terminal resistor 10 taken along a section line A-A and a section line B-B of FIG. 1. The wide terminal resistor 10 can be used in medical, communications, automotive specification applications, such as automotive charging piles, battery management systems (BMS), and engine control units (ECU), or voltage sensing applications. As shown in FIG. 1, the wide terminal resistor is of flip chip type.

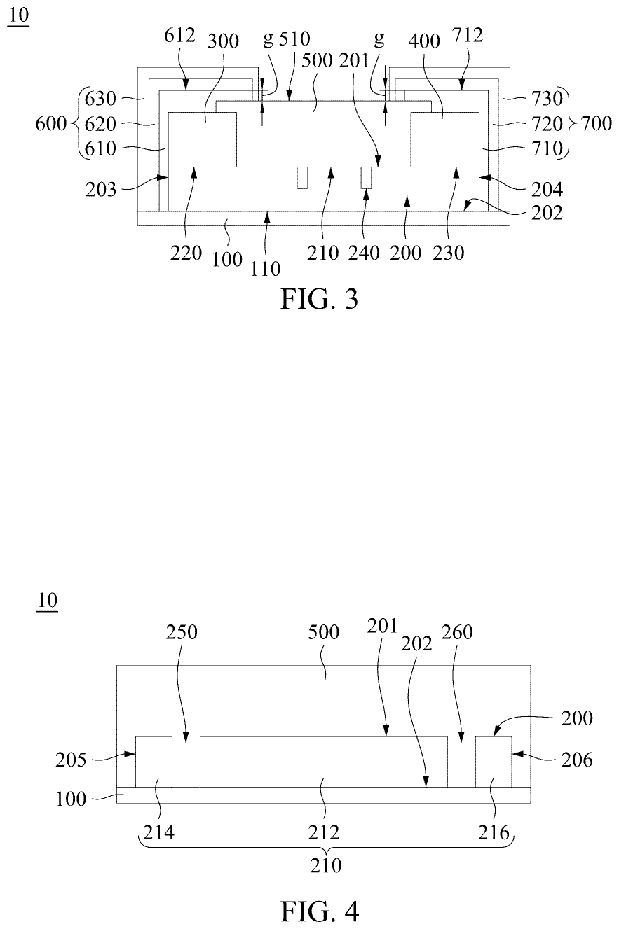

As shown in FIG. 3, the wide terminal resistor 10 may mainly include a carrier 100, a resistance layer 200, a first inner electrode 300, a second inner electrode 400, an insulating protection layer 500, a first outer electrode 600, and a second outer electrode 700. The carrier 100 may be used to carry other components of the wide terminal resistor 10. The carrier 100 may be a carrier film with adhesive on one side. For example, a surface 110 of the carrier 100 is adhesive. However, the carrier 100 may be a non-adhesive carrier film, and the present disclosure is not limited thereto. For example, the carrier 100 may be polyimide (PI), FR4, glass, ceramic, or epoxy.

The resistance layer 200 is disposed on the surface 110 of the carrier 100. The resistance layer 200 may be, for example, a resistive sheet or a resistive material deposition layer. According to product design, the shape of the resistance layer 200 may be any suitable shape, and the present disclosure is not limited thereto. In some examples, the resistance layer 200 is rectangular. As shown in FIG. 3 and FIG. 4, the resistance layer 200 has a first surface 201 and a second surface 202 that are opposite to each other, a first end surface 203 and a second end surface 204 that are opposite to each other, and a first side surface 205 and a second side surface 206 that are opposite to each other. For example, the first surface 201 and the second surface 202 may be an upper surface and a lower surface of the resistance layer 200 respectively. The first end surface 203, the second end surface 204, the first side surface 205, and the second side surface 206 may all be side surfaces of the resistance layer 200 and be located between the first surface 201 and the second surface 202. The second surface 202 is connected to the surface 110 of the carrier 100.

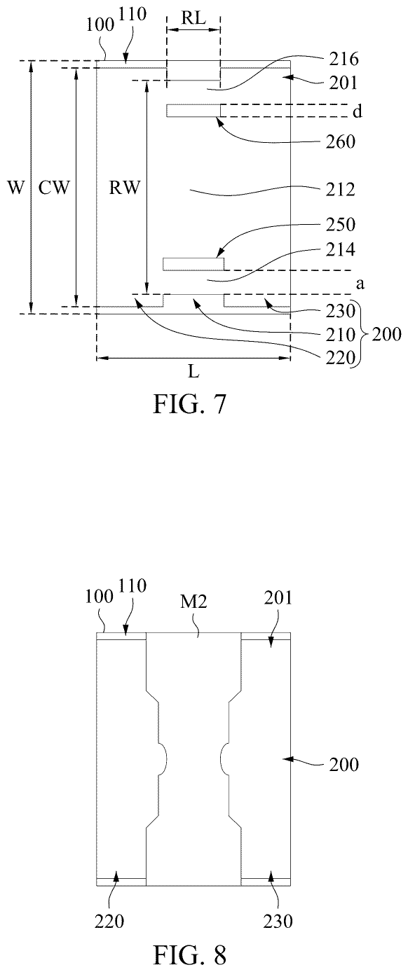

Referring to FIG. 3 and FIG. 7 simultaneously, the resistance layer 200 includes a resistance functional area 210, a first electrode area 220, and a second electrode area 230. The first electrode area 220 and the second electrode area 230 are respectively located on two opposite sides of the resistance functional area 210. The first electrode area 220 and the second electrode area 230 are respectively used to carry two electrodes of the wide terminal resistor 10. In some exemplary examples, a length RL of the resistance functional area 210 is ranging from 3/10 to 6/10 of a length L of the resistance layer 200. In some examples, the resistance layer 200 includes one or more trimming grooves 240. For example, the trimming groove 240 may be recessed from the first surface 201 of the resistance layer 200 into the resistance functional area 210.

Referring to FIG. 4 and FIG. 7 simultaneously, in some examples, the resistance layer 200 has two trenches 250 and 260. The trenches 250 and 260 are respectively disposed in two opposite edge areas of the resistance functional area 210 and extend from the first surface 201 to the second surface 202 of the resistance layer 200 to divide the resistance functional area 210 into a wide resistor 212, a first narrow resistor 214, and a second narrow resistor 216, which are connected in parallel. Specifically, the trench 250 is located between the wide resistor 212 and the first narrow resistor 214, and the other trench 260 is located between the wide resistor 212 and the second narrow resistor 216. In some exemplary examples, the first narrow resistor 214 and the second narrow resistor 216 are symmetrically arranged on two opposite sides of the wide resistor 212.

As shown in FIG. 7, a width RW of the resistance functional area 210 is smaller than a width W of the wide terminal resistor 10. Each of the first electrode area 220 and the second electrode area 230 has a width CW. The width RW of the resistance functional area 210 may be equal to or smaller than the width CW of the first electrode area 220 and the second electrode area 230. In some examples, the width CW of the first electrode area 220 and the second electrode area 230 is smaller than the width W of the wide terminal resistor 10, such that a short circuit caused by electroplating on the short edges of the resistance layer 200 during electroplating can be prevented. In some exemplary examples, the width CW of the first electrode area 220 and the second electrode area 230 is ranging from 80% to 95% of the width W of the wide terminal resistor 10.

Each of the first narrow resistor 214 and the second narrow resistor 216 has a width a, and each of the trenches 250 and 260 has a width d. In some examples, each resistance of the first narrow resistor 214 and the second narrow resistor 216 is ranging from 2 to 5 times the resistance of the middle wide resistor 212, such that the main current is concentrated on the middle wide resistor 212 that has a larger area and lower resistance. In some exemplary examples, the width RW of the resistance functional area 210 is ranging from ⅖ to ⅘ of the width W of the wide terminal resistor 10, and the width a of the first narrow resistor 214 and the second narrow resistor 216 is ranging from 10% to 20% of the width RW of the resistance functional area 210. In addition, the width d of the trenches 250 and 260 may be, for example, ranging from 50 μm to 500 μm. That is, the spacing between the first narrow resistor 214, the wide resistor 212, and the second narrow resistor 216, which are connected in parallel, is ranging from 50 μm to 500 μm.

The resistance layer 200 may be a metal alloy. For example, a material of the resistance layer 200 may be copper-manganese alloy (MnCu), copper-nickel alloy (CuNi), copper-manganese-nickel alloy (CuMnNi), copper-manganese-tin alloy (CuMnSn), nickel-chromium-aluminum alloy (NiCrAl), nickel-chromium-aluminum-silicon alloy (NiCrAlSi), or iron-chromium-aluminum alloy (FeCrAl). However, the material of the resistance layer 200 may be other suitable resistive materials, and the present disclosure is not limited thereto.

Referring to FIG. 3 and FIG. 10 simultaneously, the first inner electrode 300 is disposed on the first electrode area 220 of the resistance layer 200. The first inner electrode 300 may mainly include a first body 310, a first pedestal 320, and a first bump 330. The first pedestal 320 and the first bump 330 are sequentially connected to one side of the first body 310 and protrude toward the resistance functional area 210. Specifically, the first pedestal 320 is connected to the side of the first body 310, and the first bump 330 is connected to the first pedestal 320 and adjacent to the resistance functional area 210. The first pedestal 320 protrudes from one side of the first body 310, such that the first body 310 is wider than the first pedestal 320. The first bump 330 protrudes from the first pedestal 320, such that the first pedestal 320 is wider than the first bump 330. Thus, the first inner electrode 300 has a stepped structure.

The second inner electrode 400 is disposed on the second electrode area 230, and is separated from the first inner electrode 300 by the resistance functional area 210. The second inner electrode 400 may mainly include a second body 410, a second pedestal 420, and a second bump 430. The second pedestal 420 and the second bump 430 are sequentially connected to one side of the second body 410 and protrude toward the resistance functional area 210. Specifically, the second pedestal 420 and the second bump 430 are sequentially arranged on one side of the second body 410 in a direction toward the resistance functional area 210, and the second bump 430 and the first bump 330 are opposite to each other. The second body 410 is wider than the second pedestal 420, and the second pedestal 420 is wider than the second bump 430. Thus, the second inner electrode 400 has a stepped structure.

In some examples, the first inner electrode 300 and the second inner electrode 400 are mirror symmetrical. For example, materials of the first inner electrode 300 and the second inner electrode 400 may be copper. In some exemplary examples, each of the first bump 330 and the second bump 430 is an arc-shaped structure to prevent excessive concentration of current.

Referring to FIG. 7 and FIG. 10 simultaneously, in some examples, each of the first body 310 and the second body 410 has a length CL, and the length CL is ranging from ⅙ to 2/6 of the length L of the resistance layer 200. In addition, each of the first pedestal 320 and the second pedestal 420 has a width CW1, and the width CW1 of the first pedestal 320 and the second pedestal 420 is equal to or smaller than the width of the wide resistor 212. The first pedestal 320 and the second pedestal 420 respectively protrude from the first body 310 and the second body 410 by a length e. In some examples, this length e is ranging from 25 μm to 100 μm. The first bump 330 and the second bump 430 respectively protrude from the first pedestal 320 and the second pedestal 420 by a length S1. In some examples, the length S1 is ranging from 10 μm to 50 μm. In addition, each of the first bump 330 and the second bump 430 has a width S2, and the width S2 is ranging from 10 μm to 50 μm. Through such a design, the current and electric field can be concentrated in the middle in a stepped manner.

Referring to FIG. 2 and FIG. 3 simultaneously, the insulating protection layer 500 covers the resistance functional area 210 of the resistance layer 200, a portion of the first inner electrode 300, and a portion of the second inner electrode 400. In some examples, the insulating protection layer 500 covers the entire resistance functional area 210, the first bump 330, the first pedestal 320, and a portion of the first body 310 of the first inner electrode 300, and the second bump 430, the second pedestal 420, and a portion of the second body 410 of the second inner electrode 400. For example, a material of the insulating protection layer 500 may be epoxy, resin, epoxy containing fillers, or insulating materials, such as polyimide (PI).

Referring to FIG. 3, the first outer electrode 600 covers a portion of the insulating protection layer 500, the first inner electrode 300, and the first electrode area 220. Specifically, the first outer electrode 600 covers the portion of the insulating protection layer 500 adjacent to the first inner electrode 300, and extends from the insulating protection layer 500 to cover the first inner electrode 300, the first end surface 203 of the resistance layer 200, and the surface 110 of the carrier 100 next to the first end surface 203.

The second outer electrode 700 covers another portion of the insulating protection layer 500, the second inner electrode 400, and the second electrode area 230. Specifically, the second outer electrode 700 covers the portion of the insulating protection layer 500 adjacent to the second inner electrode 400, and extends from the insulating protection layer 500 to cover the second inner electrode 400, the second end surface 204 of the resistance layer 200, and the surface 110 of the carrier 100 next to the second end surface 204.

In some examples, the first outer electrode 600 includes a copper layer 610, a nickel layer 620, and a tin layer 630 sequentially stacked from inside to outside, and the second outer electrode 700 includes a copper layer 710, a nickel layer 720, and a tin layer 730 stacked sequentially from inside to outside. In some exemplary examples, a distance g between a top surface 510 of the insulating protection layer 500 and each of a top surface 612 of the copper layer 610 and a top surface 712 of the copper layer 710 is greater than 5 μm. This can prevent excessive solder paste from entering between the insulating protection layer 500 and the circuit board to affect the connection between the wide terminal resistor 10 and the external circuit board.

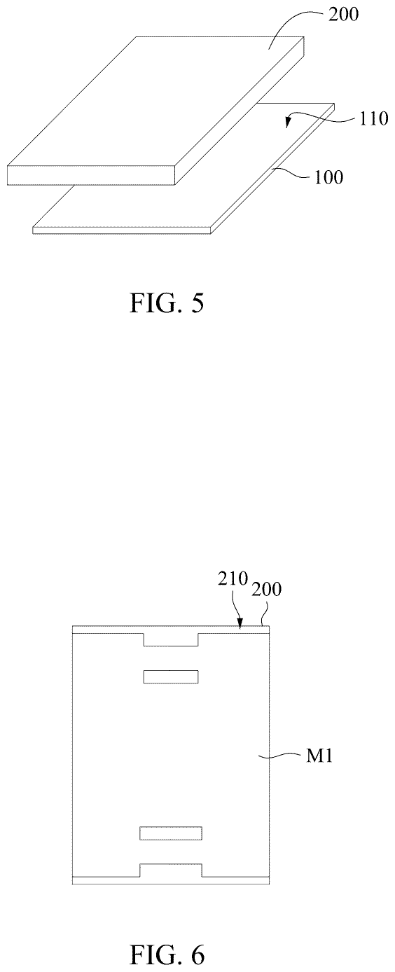

Referring to FIG. 5 through FIG. 12, FIG. 5 through FIG. 12 are schematic diagrams respectively showing intermediate stages in a method for manufacturing a wide terminal resistor 10 in accordance with one embodiment of the present disclosure. In the manufacturing of the wide terminal resistor 10 as shown in FIG. 1 through FIG. 4, the carrier 100 may be provided, and then the resistance layer 200 may be disposed on the surface 110 of the carrier 100, as shown in FIG. 5. In the example that the carrier 100 is a carrier film with adhesive on one side, the resistance layer 200 is a sheet material, such as an alloy resistive foil, and can be disposed on the surface 110 of the carrier 100 in an adhesion method. In the example that the carrier 100 is non-adhesive, the resistance layer 200 can be formed on the surface 110 of the carrier 100 by, for example, a sputtering method.

Next, as shown in FIG. 6, an etching mask layer M1 may be formed to cover the first surface 201 of the resistance layer 200 by, for example, printing, laminating, coating, or photolithography. The etching mask layer M1 is a patternable and removable etch-resistant protection layer. For example, a material of the etching mask layer M1 may be photoresist, a removable adhesive film, or a removable ink. Areas of the first surface 201 not covered by the etching mask layer M1 are the areas to be etched, which are mainly edges of the resistance layer 200 and trench areas used to form a parallel resistive structure.

Then, an etching solution for alloy metal, such as ferric chloride, copper chloride, sulfuric acid, phosphoric acid, or nitric acid is used to etch the areas of the resistance layer 200 not covered by the etching mask layer M1 until the underlying carrier 100 is exposed. After the etching of the resistance layer 200 is completed, the etching mask layer M1 may be removed by using, for example, a stripping solvent or a water washing method to expose the first surface 201 of the resistance layer 200, as shown in FIG. 7. The structure and the dimension examples of each part of the resistance layer 200 have been described above and will not be repeated herein.

Next, as shown in FIG. 8, an electroplating-resistant mask layer M2 may be formed to cover the first surface 201 of the resistance layer 200 and a portion of the exposed surface 110 of the carrier 100 by, for example, printing, laminating, coating, or photolithography. The mask layer M2 is a patternable and removable electroplating-resistant protection layer. For example, a material of the mask layer M2 may be photoresist, a removable adhesive film, or a removable ink. At this time, areas of the first surface 201 of the resistance layer 200 that are not covered by the mask layer M2 are the areas to be electroplated with inner electrodes, i.e., the first electrode area 220 and the second electrode area 230.

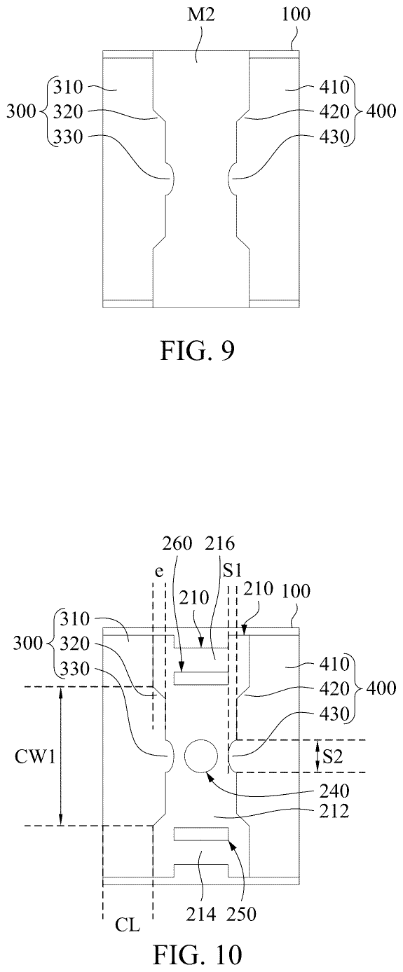

Subsequently, as shown in FIG. 9, the first inner electrode 300 may be formed on the first electrode area 220 of the resistance layer 200 and the second inner electrode 400 may be formed on the second electrode area 230 by, for example, electroplating. The structures and the dimension examples of each part of the first inner electrode 300 and the second inner electrode 400 have been described above and will not be repeated herein.

After the first inner electrode 300 and the second inner electrode 400 are formed, the mask layer M2 may be removed by using, for example, a stripping solvent or a water washing method to expose the resistance functional area 210 of the resistance layer 200 and the surface 110 of the carrier 100 covered by the mask layer M2. After the mask layer M2 is removed, a trimming operation may be optionally performed on the resistance functional area 210 of the resistance layer 200 according to product requirements to adjust the resistance of the resistance layer 200. As shown in FIG. 10, the trimming operation removes at least one portion of the resistance layer 200 to form a trimming groove 240 in the resistance layer 200. For example, laser or physical processing methods may be used to perform the trimming operation.

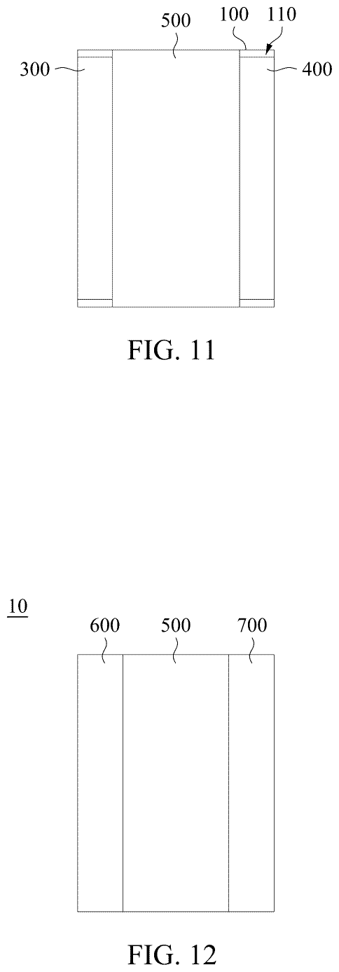

Then, the insulating protection layer 500 may be formed by, for example, printing, laminating, or photolithography. As shown in FIG. 3 and FIG. 11, the insulating protection layer 500 covers the resistance functional area 210 of the resistance layer 200, a portion of the first electrode area 220 and a portion of the first inner electrode 300 thereon, and a portion of the second electrode area 230 and a portion of the second inner electrode 400 thereon. The insulating protection layer 500 also fills the trenches 250 and 260 of the resistance layer 200 and covers a portion of the exposed surface 110 of the carrier 100.

Subsequently, as shown in FIG. 4 and FIG. 12, the first outer electrode 600 and the second outer electrode 700 are formed by, for example, electroplating to complete the manufacturing of the wide terminal resistor 10. The first outer electrode 600 and the second outer electrode 700 are opposite to and separated from each other. The first outer electrode 600 extends from the portion of the insulating protection layer 500 adjacent to the first inner electrode 300, through the first inner electrode 300 and the first end surface 203 of the resistance layer 200, to the surface 110 of the carrier 100, and covers the first inner electrode 300. The second outer electrode 700 extends from the portion of the insulating protection layer 500 adjacent to the second inner electrode 400, through the second inner electrode 400 and the second end surface 204 of the resistance layer 200, to the surface 110 of the carrier 100, and covers the second inner electrode 400. As described above with reference to FIG. 3, each of the first outer electrode 600 and the second outer electrode 700 may have a multi-layer structure. The first outer electrode 600 and the second outer electrode 700 may be formed by sequential electroplating to form the copper layers 610 and 710, the nickel layers 620 and 720, and the tin layers 630 and 730.

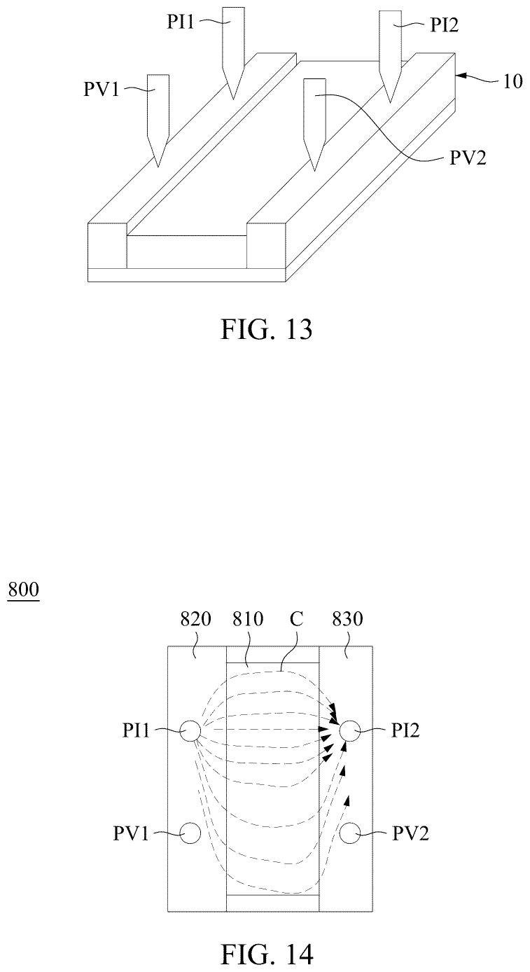

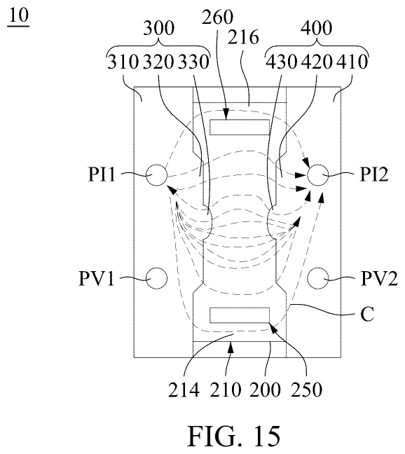

Referring to FIG. 13 through FIG. 15, FIG. 13 is a schematic diagram illustrating a resistance measurement operation of a wide terminal resistor 10 using probes PI1, PI2, PV1, and PV2, FIG. 14 and FIG. 15 respectively illustrate schematic diagrams showing paths of current C of a conventional wide terminal resistor 800 and a wide terminal resistor 10 of the present disclosure when a resistance measurement operation is performed using the probes PI1, PI2, PV1, and PV2. The probes PI1 and PI2 are current probes for applying the current C to the wide terminal resistors 10 and 800. The probes PV1 and PV2 are voltage probes for measuring the voltage of the wide terminal resistors 10 and 800. As shown in FIG. 14, the wide terminal resistor 800 mainly includes a resistance layer 810 and two electrodes 820 and 830, in which the electrodes 820 and 830 are respectively located on two opposite sides of the resistance layer 810.

As shown in FIG. 15, the middle of the first inner electrode 300 and the middle of the second inner electrode 400 of the wide terminal resistor 10 are respectively provided with the first bump 330 and the second bump 430 protruding toward the resistance functional area 210, such that the electric field can be radiated and received through the first bump 330 and the second bump 430 to provide a shortest path. The design is similar to that a set of probes are provided at fixed positions of the inner terminal electrodes, such that the resistance measurement can be stable. In addition, as shown in FIG. 14 and FIG. 15, during the probe measurement, compared to the design of the conventional wide terminal resistor 800, the design of the wide terminal resistor 10 can make it easier for the current C to be concentrated in the middle area.

Furthermore, the resistance functional area 210 of the resistance layer 200 of the wide terminal resistor 10 includes a parallel resistor structure, and the first narrow resistor 214 and the second narrow resistor 216 on two ends of the short side of the wide terminal resistor 10 are narrower than the wide resistor 212 in the middle. As a result, the current C flowing through the first narrow resistor 214 and the second narrow resistor 216 on the two ends is less, and the current C is mainly concentrated near the first bump 330 and the second bump 430 in the middle, as shown in FIG. 15. It can be seen from FIG. 14 and FIG. 15 that compared with the design of the conventional wide terminal resistor 800, the design of the wide terminal resistor 10 can make the current C more concentrated, such that the measurement is more stable.

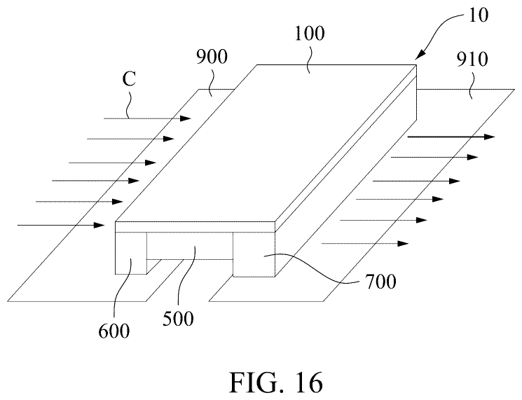

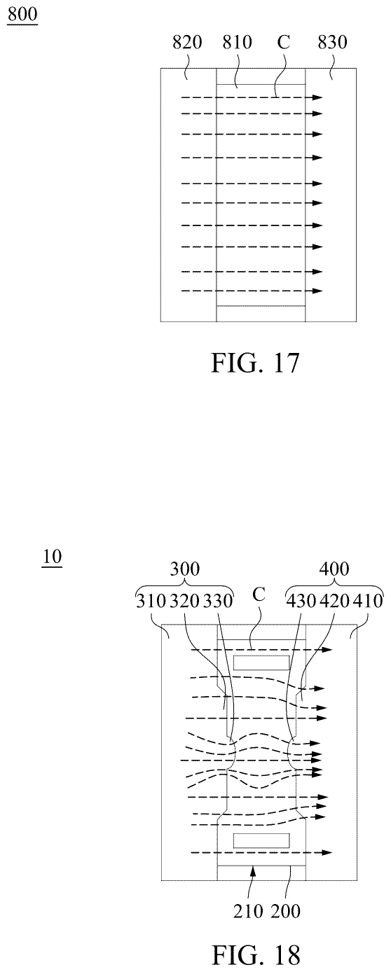

Referring to FIG. 16 through FIG. 18, FIG. 16 is a schematic diagram illustrating a resistance measurement operation of a wide terminal resistor 10 after being mounted on a circuit board, FIG. 17 and FIG. 18 respectively illustrate schematic diagrams showing paths of current C of a conventional wide terminal resistor 800 and a wide terminal resistor 10 of the present disclosure after the wide terminal resistors 800 and 10 are mounted on a circuit board. As shown in FIG. 16, the first outer electrode 600 and the second outer electrode 700 of the wide terminal resistor 10 are respectively soldered to solder pads 900 and 910 of the circuit board. Similarly, the wide terminal resistor 800 can be mounted on the circuit board by soldering electrodes 820 and 830 to the solder pads 900 and 910 respectively. As shown in FIG. 17 and FIG. 18, after being mounted on the circuit board, the current C can flow through the resistance layer 200 of the wide terminal resistor 10 and the resistance layer 810 of the wide terminal resistor 800 relatively uniformly.

The following uses comparative examples and embodiments to more specifically illustrate the technical content and the efficacies of the present embodiment, but it is not intended to limit the present disclosure. Any person having ordinary skill in the art of the present disclosure can make various changes and modifications without departing from the spirit and scope of the present disclosure.

Taking the 1 mΩ wide terminal resistor of the surface mount device SMD 0612 as an example, the carriers of the wide terminal resistors of the comparative example and the embodiment are polyimide, the metal alloy materials of the resistance layers are CuMnNi, and the thicknesses of the resistance layers are 0.1 mm. In addition, in the wide terminal resistor of the comparative example, the widths of the electrode areas of the resistance layer are 3.0 mm, the lengths of the inner electrodes are 0.5 mm, the length of the resistance functional area is 0.6 mm, and the width of the resistance functional area is 2.7 mm. In the wide terminal resistor of the embodiment, the widths of the electrode areas of the resistance layer is 3.0 mm, the widths of the pedestals of the inner electrodes are 1.6 mm, the lengths of the bodies of the inner electrodes are 0.43 mm, the protrusion lengths of the pedestals are 0.05 mm, the protrusion lengths of the bumps are 0.03 mm, the width of the resistance functional area is 2.86 mm, the length of the resistance functional area is 0.6 mm, the widths of the narrow resistors are 0.46 mm, and the widths of the trenches are 0.15 mm. Each of the wide terminal resistors of the comparative example and embodiment is physically drilled and polished to trim to achieve a resistance of 1 mΩ during the manufacturing process.

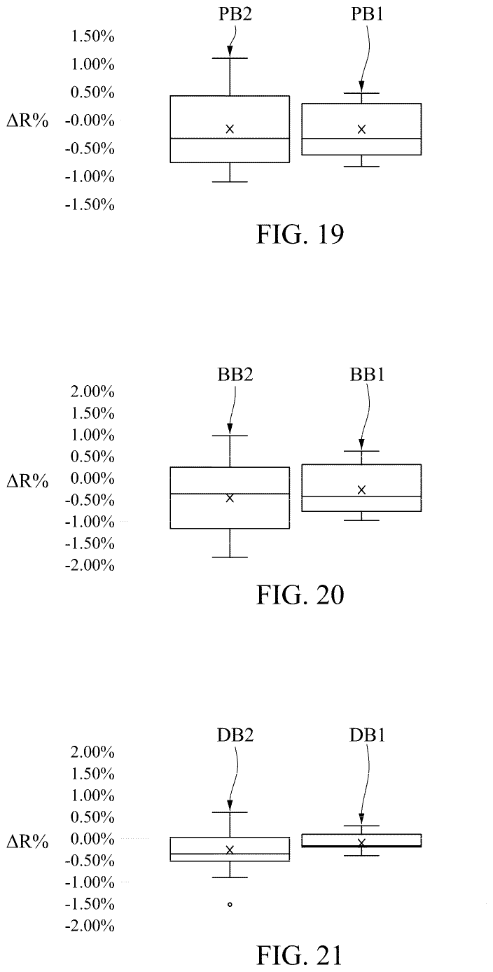

Referring to FIG. 19 through FIG. 21, FIG. 19 through FIG. 21 respectively illustrate a comparison diagram of box plots PB1, PB2, BB1, BB2, DB1, and DB2 of data of wide terminal resistors of one embodiment of the present disclosure and a comparative example when a resistance measurement operation is performed using probes, when a resistance measurement operation is performed after the wide terminal resistors are mounted on circuit boards, and resistance differences of the wide terminal resistors of one embodiment of the present disclosure and the comparative example between using the probes and after being mounted on the circuit board. In FIG. 19 through FIG. 21, each vertical axis is ΔR %, which is the percentage of the difference between the actual measured value and the standard value relative to the standard value, in which the standard value is the resistance of the wide terminal resistor. The products of the wide terminal resistors of the comparative example and the embodiment are respectively subjected to probe screening measurement. It can be seen from the box plot PB2 in FIG. 19 that the average value (AVG) of the wide terminal resistor of the comparative example is −0.16%, and the standard deviation (SD) is 0.65%. It can be seen from the box plot PB1 in FIG. 19 that the average value (AVG) of the wide terminal resistor of the embodiment is −0.17%, and the standard deviation (SD) is 0.46%.

After the products are subjected to the probe screening measurement, the products are soldered to a printed circuit board and are respectively subjected to resistance measurement. It can be seen from the box plot BB2 in FIG. 20 that the average value (AVG) of the wide terminal resistor of the comparative example is −0.45%, and the standard deviation (SD) is 0.76%. It can be seen from the box plot BB1 in FIG. 20 that the average value (AVG) of the wide terminal resistor of the embodiment is −0.27%, and the standard deviation (SD) is 0.56%.

The resistance differences between measured by using the probes and on the circuit board of the embodiment and the comparative example are analyzed. It can be seen from the box plot DB2 in FIG. 21 that the average value (AVG) of the wide terminal resistor of the comparative example is −0.29%, and the standard deviation (SD) is 0.45%. It can be seen from the box plot DB1 of FIG. 21 that the average value (AVG) of the wide terminal resistor of the embodiment is −0.10%, and the standard deviation (SD) is 0.20%.

From the above experimental results, it can be seen that compared with the comparative example, the probe screening accuracy of the wide terminal resistor of the embodiment can be increased by about 0.5% (full range), the value concentration is reduced by 0.8% (full range) after screening and being mounted on the circuit board, the numerical error between measured by using the probes and on the circuit board can be reduced by approximately 0.2%, and the standard deviation (SD) is reduced by 0.2%.

According to the above embodiments, the first inner electrode and the second inner electrode of the wide terminal resistor of the present disclosure are respectively provided with the first bump and the second bump protruding toward the resistance functional area, such that the electric field and current can be concentrated on the first bump and the second bump, which makes the probe measurement more stable. Therefore, the accuracy of the probe measurement of the wide terminal resistor can be increased, and the error between the probe measurement and the measurement on the circuit board of the wide terminal resistor can be effectively reduced.

In addition, the resistance functional area of the resistance layer is provided with two trenches to divide the resistance functional area into a wide resistor, and a first narrow resistor and a second narrow resistor located at two outer sides of the wide resistor. The design can make the electric field on the edges of the resistance functional area uniform, disperse the resistance of the resistor, and achieve uniform heat distribution. Furthermore, the resistance of the first narrow resistor and the second narrow resistor are relatively high, and the electric field can be more concentrated in the central area of the resistance functional area.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A wide terminal resistor, comprising:
a carrier;
a resistance layer disposed on the carrier, wherein the resistance layer comprises a resistance functional area, and a first electrode area and a second electrode area respectively located on two opposite sides of the resistance functional area;
a first inner electrode disposed on the first electrode area, wherein the first inner electrode comprises a first body, and a first pedestal and a first bump sequentially connected to one side of the first body;
a second inner electrode disposed on the second electrode area, wherein the second inner electrode comprises a second body, and a second pedestal and a second bump sequentially connected to one side of the first body, and the second bump and the first bump are opposite to each other;
an insulating protection layer covering the resistance functional area, a portion of the first inner electrode, and a portion of the second inner electrode;
a first outer electrode covering a portion of the insulating protection layer, the first inner electrode, and the first electrode area; and
a second outer electrode covering another portion of the insulating protection layer, the second inner electrode, and the second electrode area, and being opposite and separated from the first outer electrode.

2. The wide terminal resistor of claim 1, wherein the resistance layer has two trenches, the trenches respectively pass through two opposite edge areas of the resistance functional area to divide the resistance functional area into a wide resistor, a first narrow resistor, and a second narrow resistor that are connected in parallel, and the first narrow resistor and the second narrow resistor are symmetrically arranged on two opposite sides of the wide resistor.

3. The wide terminal resistor of claim 2, wherein each of a width of the first narrow resistor and a width of the second narrow resistor is ranging from 10% to 20% of a width of the resistance functional area, and a width of each of the trenches is ranging from 50 μm to 500 μm.

4. The wide terminal resistor of claim 2, wherein a resistance of each of the first narrow resistor and the second narrow resistor is ranging from 2 to 5 times a resistance of the wide resistor.

5. The wide terminal resistor of claim 2, wherein each of a width of the first pedestal and a width of the second pedestal is equal to or smaller than a width of the wide resistor.

6. The wide terminal resistor of claim 2, wherein each of a length of the first pedestal protruding from the side of the first body and a length of the second pedestal protruding from the side of the second body is ranging from 25 μm to 100 μm, each of a length of the first bump protruding from the first pedestal and a length of the second bump protruding from the second pedestal is ranging from 10 μm to 50 μm, and each of a width of the first bump and a width of the second bump is ranging from 10 μm to 50 μm.

7. The wide terminal resistor of claim 2, wherein a width of the resistance functional area is ranging from ⅖ to ⅘ of a width of the wide terminal resistor, and each of a width of the first electrode area and a width of the second electrode area is ranging from 80% to 95% of the width of the wide terminal resistor.

8. The wide terminal resistor of claim 2, wherein a length of the resistance functional area is ranging from 3/10 to 6/10 of a length of the resistance layer, and each of a length of the first body and a length of the second body is ranging from ⅙ to 2/6 of a length of the resistance layer.

9. The wide terminal resistor of claim 1, wherein each of the first bump and the second bump is an arc-shaped structure.

10. The wide terminal resistor of claim 1, wherein the first inner electrode is mirror symmetrical to the second inner electrode.
